(19) United States
(12) Patent Application Publication
(10) Pub. No.: US 2003/0020645 A1
(43) Pub. Date: Jan. 30, 2003

(54) Infrared remote control system having repeater type illumination unit

(75) Inventor: Hiroshi Akiyama, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/193,303

(22) Filed: Jul. 12, 2002

(30) Foreign Application Priority Data
Jul. 27, 2001 (JP) 2001-228190

(51) Int. Cl. G08C 19/12; G08C 19/00; H04L 17/02

(52) U.S. Cl. 341/176; 340/825.72; 348/734

(57) ABSTRACT

In an infrared remote control system including an infrared remote-controlled illumination unit having an illumination, at least one infrared remote-controlled electrical unit, a first infrared remote control transmitter for the illuminator and at least one second infrared remote control transmitter for the infrared remote-controlled electrical unit, the infrared remote-controlled illumination unit is constructed by a receiving unit for receiving an infrared control signal from one of the first and second infrared remote control transmitters, a driver for driving the illuminator; a retransmitting unit for retransmitting the infrared control signal to the infrared remote-controlled electrical unit, and a control unit for determining whether the infrared control signal received by the receiving unit is generated from the first infrared remote control transmitter or from the second infrared remote control transmitter, so that the control unit operates the driver to turn ON or OFF the illuminator when the infrared control signal is generated from the first infrared remote control transmitter, and the control unit operates the retransmitting unit to retransmit the infrared control signal to the second infrared-controlled electrical unit when the infrared control signal is generated from the second infrared remote control transmitter.

### BACKGROUND OF THE INVENTION

1. Field of the Invention

The present invention relates to an infrared remote control system for controlling various electrical units using infrared rays.

2. Description of the Related Art

Infrared remote control systems have been broadly used to control an electrical unit such as an illumination unit, a television set, a video apparatus or an air conditioner. That is, when an infrared remote control transmitter generates an infrared control signal, the electrical unit is controlled by receiving the infrared control signal. In this case, when the infrared remote control transmitter and is distant from the electrical unit or when an obstacle is present therebetween, the electrical unit cannot receive the infrared control signal from the infrared remote control transmitter. This will be explained later in detail.

In order to obviate the above-mentioned problem, a repeater is provided between the infrared remote control transmitter and the electrical unit. For example, such a repeater is provided on a floor (see: JP-A-8-256387, JP-A-10-117390& JP-A-10-271576) or at a ceiling (see: JP-A-8-294182).

In a case where the repeater is provided on the floor, however, the repeater per se is an obstacle, so that a dead angle is generated for a television set or the like or a person cannot freely travel on the floor. Also, when a person is present between the infrared remote control transmitter and the repeater or between the repeater and the electrical unit, the electrical unit cannot receive the infrared control signal. Further, if the repeater includes the same type infrared receiver as in the electric unit, the repeater cannot respond to various kinds of electrical units.

On the other hand, in a case where the repeater is provided at the ceiling, the repeater may not serve as an obstacle, so that there is no dead angle for a television set or the like or a person can freely travel on the floor. However, an additional installation for fixing the repeater to the ceiling by a double-coated tape or screws is required, which would increase the cost and would contaminate and ruin the ceiling. Further, the ceiling would become poor-looking.

Additionally, the above-mentioned prior art repeater is not applicable to drive a plurality of electrical units.

### SUMMARY OF THE INVENTION

It is an object of the present invention to provide an infrared remote control system where no dead angle is generated for a television set or the like, a person can freely travel on the floor, and no additional installation is required.

Another object is to provide an infrared remote control system having a repeater applicable to a plurality of electrical units.

According to the present invention, in an infrared remote control system including an infrared remote-controlled illumination unit having an illuminator, at least one infrared remote-controlled electrical unit, a first infrared remote control transmitter for the illuminator and at least one second infrared remote control transmitter for the infrared remote-controlled electrical unit, the infrared remote-controlled illumination unit is constructed by a receiving unit for receiving an infrared control signal from one of the first and second infrared remote control transmitters, a driver for driving the illuminator, a retransmitting unit for retransmitting the infrared control signal to the infrared remote-controlled electrical unit, and a control unit for determining whether the infrared control signal received by the receiving unit is generated from the first infrared remote control transmitter or from the second infrared remote control transmitter, so that the control unit operates the driver to turn ON or OFF the illuminator when the infrared control signal is serenaded from the first infrared remote control transmitter, and the control unit operates the retransmitting unit to retransmit the infrared control signal to the second infrared-controlled electrical unit when the infrared control signal is generated from the second infrared remote control transmitter.

Since the illumination unit is usually fixed to a ceiling, no dead angle is generated for a television set or the like and a person can freely travel on the floor. Also, since the illumination unit per se is installed at the ceiling, no additional installation of a repeater formed by the receiving unit, the driver, the retransmitting unit and the control unit is required. Also, there is no limitation in the number of electrical units.

### BRIEF DESCRIPTION OF THE DRAWINGS

The present invention will be more clearly understood from the description set forth below, as compared with the prior art, with reference to the accompanying drawings, wherein:

FIG. 1 is a block diagram illustrating a prior art infrared remote control system;

FIG. 2 is a block diagram illustrating an embodiment of the infrared remote control system according to the present invention;

FIG. 3 is a detailed block circuit diagram of the repeater type illumination unit of FIG. 2; and

FIG. 4 is a flowchart for explaining the operation of the control unit of FIG. 3.

### DESCRIPTION OF THE PREFERRED EMBODIMENT

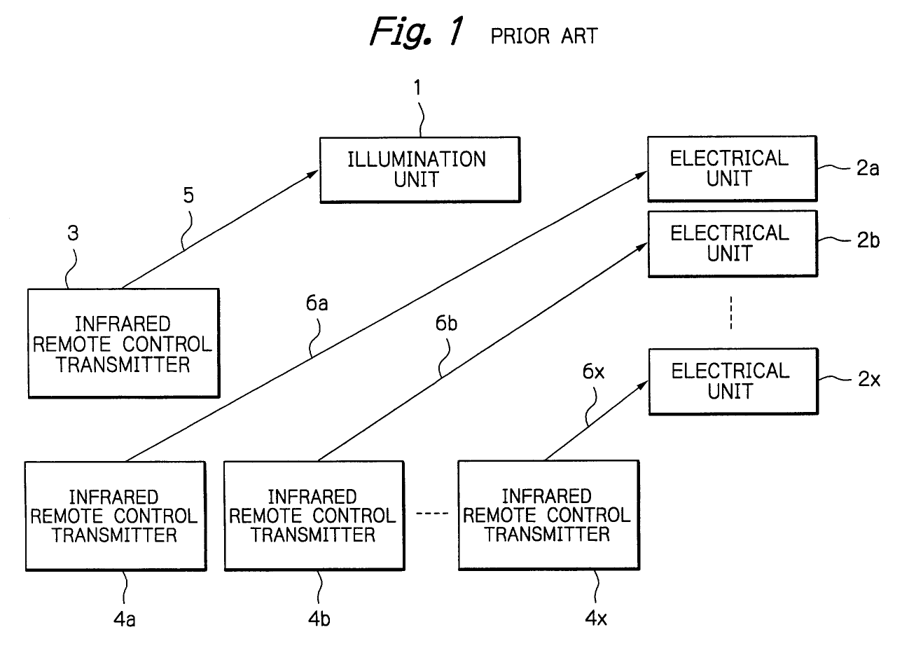

Before the description of the preferred embodiment, a prior art infrared remote control system will be explained with reference to FIG. 1.

In FIG. 1, an illumination unit 1 is fixed at a ceiling, and other electrical units 2a, 2b, . . . , 2x such as a television set, an video apparatus and an air conditioner are provided on a floor. The illumination unit 1 and the electrical units 2a, 2b, . . . , 2x are controlled by infrared remote control transmitters 3, 4a, 4b, . . . , respectively. That is, when each of the infrared remote control transmitters 3, 4a, 4b,. . . , 4x generate infrared control signals 5, 6a, 6b, . . . , 6x, respectively, having specific data codes, the illumination unit 1 and the electrical units 2a, 2b, . . . , 2x respond to the infrared control signals 5, 6a, 6b, . . . , 6x, respectively.

In FIG. 1, when the infrared remote control transmitter such as 4a and is distant from the electrical unit 2a or when an obstacle is present therebetween, the electrical unit 2a cannot receive the infrared control signal 6a from the infrared remote control transmitter 4a. In order to obviate the above-mentioned problem, repeaters (not shown) are provided between the infrared remote control transmitters 4a, 4b, . . . , 4x and the electrical units 2a, 2b, . . . , 2x.

However, as stated above, a dead angle is generated for each of the electrical units, and a person cannot freely travel on the floor. Also, if the repeater is fixed at a ceiling, an additional installation is required. Further, since one infrared remote control transmitter is required for each of the electrical units 2a, 2b, . . . , 2x, the cost is increased.

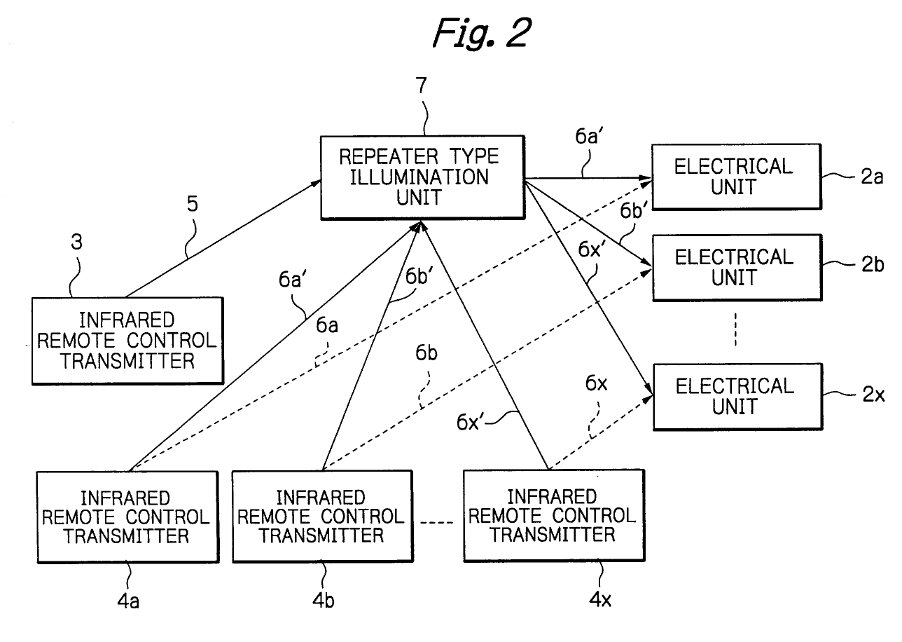

In FIG. 2, which illustrates an embodiment of the present invention, a repeater type illumination unit 7 is provided instead of the repeaters of FIG. 1 provided on the floor. The repeater type illumination unit 7 serves as repeaters between the infrared remote control transmitters 4a, 4b, . . . , 4x and the electrical units 2a, 2b, . . . , 2x. That is, when the repeater type illumination unit 7 receives infrared control signals 6a′, 6b′, . . . , 6x ′ from the infrared remote control transmitters 4a, 4b, . . . , 4x, the repeater type illumination unit 7 retransmits the infrared control signals 6a′, 6b′, . . . , 6x′ to the electrical units 2a, 2b, . . . , 2x.

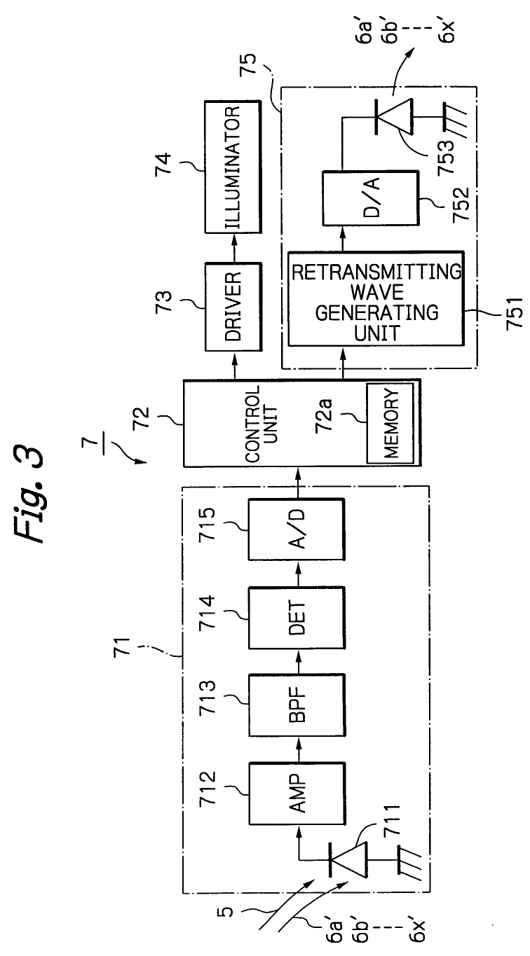

In FIG. 3, which is a detailed circuit diagram of the repeater type illumination unit 7 of FIG. 2, the repeater type illumination unit 7 is constructed by a receiving unit 71 for receiving the infrared control signals 5, 6a′, 6b′, . . . , 6x′ from the infrared remote control transmitters 4a, 4b, . . . , 4x, a control unit 72 formed by a microprocessor, a memory 72a and the like, a driver 73 for driving an illuminator 74, and a retransmitting unit 75 for retransmitting the infrared control signals 6a′, 6b′, . . . , 6x′ to the electrical units 2a, 2b, . . . , 2x.

In more detail, the receiving unit 71 is constructed by a light receiving diode 711 for receiving the infrared control signals 5, 6a′, 6b′, . . . , 6x′ to generate a current signal, an amplifier 712 for amplifying the current signal of the light receiving diode 711, a bandpass filter 713 for passing a desired frequency component of the output of the amplifier 712, a detector 714 for detecting data codes in the output signal of the bandpass filter 713, and an analog/digital (D/A) converter 714 for performing a D/A conversion upon the data codes detected by the detector 714.

Also, the retransmitting unit 75 is constructed by a retransmitting wave generating unit 751 for generating a retransmitting wave, a D/A converter 752 for performing a D/A conversion upon the retransmitting wave, and a light emitting diode 753 for generating infrared control signals in accordance with the output signal of the D/A converter 752.

Note that the repeater type illumination unit 7 serves a hub for the electrical units 2a, 2b, . . . , 2x.

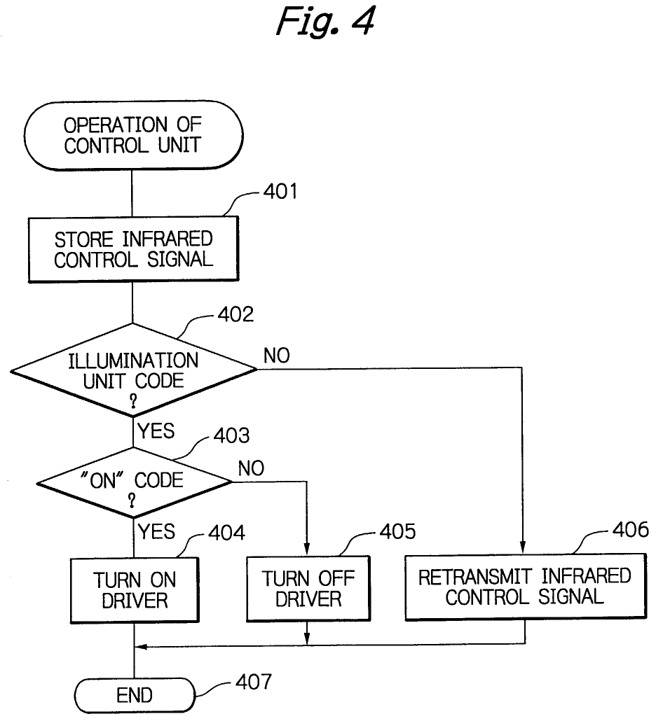

The operation of the control unit 72 is explained next with reference to FIG. 4.

First, at step 401, the received infrared control signal, i.e., the digital data of the A/D converter 715 is stored in the memory 72a.

Next, at step 402, it is determined whether the stored infrared control signal is generated from the infrared remote control transmitter 3 or from one of the infrared remote control transmitters 4a, 4b, . . . , 4x. That is, the control unit 72 determines whether or not the data code in the stored infrared control signal includes an apparatus code for the illumination unit 7 (or the illuminator 74). As a result, when the stored infrared control signal is generated from the infrared remote control transmitter 3, the control proceeds to step 403. On the other hand, when the stored infrared control signal is generated from one of the infrared remote control transmitters 4a, 4b, . . . , 4x, the control proceeds to step 406.

At step 403, it is determined whether a control code in the stored infrared control signal is “ON” or “OFF”. As a result, when the control code is “ON”, the control proceeds to step 404 which turns ON the illuminator 74. On the other hand, when the control code is “OFF”, the control proceeds to step 405 which turns OFF the illuminator 74.

At step 406, the retransmitting unit 75 is operated. That is, the retransmitting wave generating unit 751 generates retransmitting waves corresponding to one of the infrared control signals 6a′, 6b′, . . . , 6x′ in accordance with the data stored in the memory 72a. As a result, the light emitting diode 753 generates the same infrared control signal as the infrared control signal received by the receiving unit 71.

The operation of FIG. 4 is completed by step 407.

In the above-described embodiment, since the operation of the control unit 72 does not need apparatus codes of the electrical units 2a, 2b, . . . 2x, even if the electrical units 2a, 2b, . . . , 2x are changed or removed or even if new electrical units are installed, it is unnecessary to adjust the control unit 72.

As explained hereinabove, according to the present invention, since an illumination unit serves as a repeater, no dead angle is generated for each electrical unit, and a person can freely travel on the floor. Also, since no additional installation is required, the cost can be decreased. Further, since one infrared remote control transmitter is not required for each electrical unit, the cost can be also decreased.

1. An infrared remote control system comprising:
an infrared remote-controlled illumination unit having an illuminator;
at least one infrared remote-controlled electrical unit;
a first infrared remote control transmitter for said illuminator; and
at least one second infrared remote control transmitter for said infrared remote-controlled electrical unit,
said infrared remote-controlled illumination unit comprising:
a receiving unit for receiving an infrared control signal from one of said first and second infrared remote control transmitters;
a driver for driving said illuminator;
a retransmitting unit for retransmitting said infrared control signal to said infrared remote-controlled electrical unit; and
a control unit, connected to said receiving unit, said driver and said retransmitting unit, for determining whether said infrared control signal received by said receiving unit is generated from said first infrared remote control transmitter or from said second infrared remote control transmitter, so that said control unit operates said driver to turn ON or OFF said illuminator when said infrared control signal is senerated from said first infrared remote control transmitter, and said control unit operates said retransmitting unit to retransmit said infrared control signal to said second infrared-controlled electrical unit when said infrared control signal is generated from said second infrared remote control transmitter.

2. The system as set forth in claim 1, wherein said receiving unit comprises:
an infrared light receiving element for receiving said infrared control signal;
an amplifier, connected to said infrared light receiving element, for amplifying an output signal of said infrared light receiving element;
a bandpass filter, connected to said amplifier, for passing a desired frequency component of an output signal of said amplifier;
a detector, connected to said bandpass filter, for detecting data codes in an output signal of said bandpass filter; and
an analog/digital converter, connected between said detector and said control unit, for performing an analog/digital conversion upon an output signal of said detector.

3. The system as set forth in claim 1, wherein said control unit comprises a memory for storing said infrared control signal received by said receiving unit.

4. The system as set forth in claim 3, wherein said retransmitting unit comprises:
a retransmitting wave generating unit for generating a retransmitting wave in accordance with said infrared control signal stored in said memory;
a digital/analog converter, connected to said retransmitting wave generating unit, for performing a digital/analog conversion upon an output signal of said retransmitting wave generating unit; and
an infrared light emitting element, connected to said digital/analog converter, for generating an infrared control signal.

5. An infrared remote control system comprising:
a first infrared remote-controlled electrical unit capable of being fixed at a ceiling;
at least one second infrared remote-controlled electrical unit;
a first infrared remote control transmitter for said first electrical unit; and
at least one second infrared remote control transmitter for said second infrared remote-controlled electrical unit,
said first infrared remote-controlled electrical unit comprising:
a receiving unit for receiving an infrared control signal from one of said first and second infrared remote control transmitters;
a retransmitting unit for retransmitting said infrared control signal to said second infrared remote-controlled electrical unit; and
a control unit, connected to said receiving unit and said retransmitting unit, for determining whether said infrared control signal received by said receiving unit is generated from said first infrared remote control transmitter or from said second infrared remote control transmitter, so that said control unit operates said first electrical unit when said infrared control signal is senerated from said first infrared remote control transmitter, and said control unit operates said retransmitting unit to retransmit said infrared control signal to said second infrared-controlled electrical unit when said infrared control signal is generated from said second infrared remote control transmitter.

6. The system as set forth in claim 5, wherein said receiving unit comprises:
an infrared light receiving element for receiving said infrared control signal;
an amplifier, connected to said infrared light receiving element, for amplifying an output signal of said infrared light receiving element;
a bandpass filter, connected to said amplifier, for passing a desired frequency component of an output signal of said amplifier;
a detector, connected to said bandpass filter, for detecting data codes in output signal of said bandpass filter; and
an analog/digital converter, connected between said detector and said control unit, for performing an analog/digital conversion upon an output signal of said detector.

7. The system as set forth in claim 5, wherein said control unit comprises a memory for storing said infrared control signal received by said receiving unit.

8. The system as set forth in claim 7, wherein said retransmitting unit comprises:
a retransmitting wave generating unit for generating a retransmitting wave in accordance with said infrared control signal stored in said memory;
a digital/analog converter, connected to said retransmitting wave generating unit, for performing a digital/analog conversion upon an output signal of said retransmitting wave generating unit; and
an infrared light emitting element, connected to said digital/analog converter, for generating an infrared control signal.
